(19) United States
(12) Patent Application Publication
(10) Pub. No.: US 2007/0285916 A1
(43) Pub. Date: Dec. 13, 2007

(54) Keyed Replaceable Lamp

(76) Inventors: Karlheinz Strobl, Mt Sinai, NY (US); Karim Hamdi, Brooklyn, NY (US)

Correspondence Address: LILLIE LAW, LLC, 269 SOUTHPORT ST, RONKONKOMA, NY, 11779, US

(21) Appl. No.: 11/757,555

(22) Filed: Jun. 4, 2007

Related U.S. Application Data
(60) Provisional application No. 60/803,805, filed on Jun. 2, 2006.

(51) Int. Cl. F21V 19/02

(52) U.S. Cl. 362/220; 362/285

(57) ABSTRACT

The present invention is directed to the design and manufacturing of prealigned, keyed, removable, double end mounted arc lamps that enable, inter alia, end-users to perform an alignment free, bare lamp replacement in a lamp reflector module in the field of projection display systems and fiber optic illumination systems.

### RELATED APPLICATION(S)

This application is related and claims priority to provisional application(s) (i) having Ser. No. 60/803,805 filed 02 Jun. 2006

### BACKGROUND

1. Field of Invention

The present invention is directed to the design and manufacturing of a keyed replaceable lamp that enables, inter alia, end-users to perform a reliable lamp replacement in connection with a reflector system and a respective double end lamp holder, more particularly, the present invention relates to the field of projection display systems and fiber optic illumination systems.

2. Description of Background

U.S. Pat. No. 6,356,700 issued to Strobl (hereafter '700 to Strobl), to an inventor of the present invention involves the utilization of eele-enhanced® reflectors, and pending U.S. patent application Ser. No. 11/419,976 provides a delivery system for removable lamps that increases safety during lamp replacement in connection with eele-enhanced® reflectors, while setting forth the advantages of using keyed lamps with matching keyed lamp mounting systems to provide a safer, alignment free “plug and play” lamp exchange by an end user. FIG. 4. of U.S. patent application Ser. No. 11/419,976 illustrates, for example, a prior art step-in feature on a respective lamp ferrule (also called socket) having a matching step-out feature in a corresponding lamp mounting. However, the present invention illustrates, particularly in the case of an eele-enhanced® reflector system, that such a prior art step-in features of the lamp mounting ferrule require the lamp to be pushed along the lamp axis from the opposite ferrule side against a matching step-out feature of the lamp mounting system to prevent a slow wandering of the optical electrode center of the lamp along the lamps axis due to thermal cycling of lamp, which would cause an undesirable output loss. The small force needed to prevent this position stability error in the prior art needs to be directed towards the center of the envelope, and therefore is fighting against its natural thermal expansion direction resulting increased stress and possible premature envelope failures. The more the lamp gets the used the less the envelope can withstand pressure differentials and the less force it takes to cause its fracture. Therefore, an improved lamp mounting keying system is needed to increase the reliability of a double end mounted end user replaceable lamp.

This present invention is related to '700 to Strobl, and of the U.S. patent application Ser. No. 11/419,976. The present invention relates in particular to an improved keyed replaceable lamp family that enables a more reliable operation of an end user replaceable lamp in connection with a double ended lamp mounting system. Lifetime and operator safety is further improved if the herein described invention is combined or used in conjunction with '700 to Strobl.

Therefore, it is first advantage of the present invention to provide a special key family for a double end mounted lamp that mechanically interlocks to a suitably keyed lamp holder without limiting the thermal expansion of the lamp during its on/off operation.

It is a second advantage of the present invention to provide an alignment free and permanent position stable five-point keyed mounting system between a lamp mounting system and a double end mounted lamp.

It is a third advantage of the present invention to enable a rotation limiting key for an end user replaceable double end mounted lamps.

It is a fourth advantage of the present invention to combine the eele-enhanced® lamp reflector module technology with a double end mounted, end-user replaceable arc lamp, and with an installation/removal tool; and to provide additional alignment key and/or lamp type recognition features that facilitate error free end user lamp replacement capability in connection with an eele-enhanced® lamp reflector module or other multi reflector based light collection and concentration systems.

### SUMMARY OF THE INVENTION

The present invention is directed towards prealigned, double end mounted, arc lamps that have two ferrules incorporating precision mechanical key alignment features. In particular, the present invention applies to end-user replaceable lamps in connection with eele-enhanced® reflectors or other multi reflector based light collection and concentration systems, whether installed with or without a protective enclosure as set forth in U.S. patent application Ser. No. 11/419,976.

In a first embodiment of the present invention, a double end mounted arc lamp is mounted onto two different ferrules (e.g., a Hg, Xe or metal halide arc lamp, DC or AC, low or high pressure). Each ferrule has an axial symmetric alignment feature for two dimensional confinement of the ferrule perpendicular to the lamp direction X. For example, at least an alignment section of the each ferrule preferably has a cross-sectional shape such as a cylindrical, triangular, trapezoidal, rectangular, square or other shape, wherein the alignment section provides a two dimensional mechanical confinement with appropriate lamp mounting reference points or surfaces without limiting the positioning of the ferrule in the lamp axis X direction to a narrow range in X.

At least one of the ferrules has a raised section (step-out) that provides a unique mechanical stop (key) in the X direction in a mounting feature having a lowered (step-in) section that interlocks with the raised section permitting the lamp to expand away from the X direction location key. In this manner, a five-point alignment key is provided that enables an easy transfer of the alignment of the optical arc center at the lamp factory, where preferably the lamp is aligned with cameras to an optimum given spatial reference location and then is permanently cemented into the respective ferrule pair. Thus, at the same time, a stress free mounting of such a double end mounted lamp into a respective lamp holder mounting pair is procured that further has an accurate standard spatial relationship to the first focal point F1 of the respective reflector system. Preferably, the five-point mechanical locating keys are integral portions of a respective reflector. For example, the keys are built into the sides or flanges of at least one respective - reflector component. Similarly, additional alignment key features exist between the various reflector components comprising the reflector system.

In another preferred embodiment of the key system, a mechanical key enables the end user to position the lamp into the lamp mount substantially in only one predetermined rotational way, wherein the position of the lamp is unique with respect to the reflector and the mechanical locating keys are sufficiently defined so as to prohibit a positioning error during lamp insertion into the lamp mount (e.g., left right, up, down, different axial rotation). Moreover, the lamp mounting keys are preferably configured and dimensioned such that the insertion and/or activation (power up) of incorrect lamp types is prevented. For example, for a given illumination system having a cooling solution and power supply, only a narrow range of lamp types are compatible and inadvertent use of incorrect lamp is prevented. This can be accomplished in a plethora of ways, for example, (i) having additional mechanical key features on one or both ferrules, or (ii) by changing the spacing between (a) the two ferrules or (b) of least one of their respective additional key features and/or (iii) alpha numeric key entry into a illumination system, and a check and authorization procedure(s) that enable or disables the power up mode of the lamp power supply.

### BRIEF DESCRIPTION OF THE DRAWINGS

In order for the present invention to be clearly understood and readily practiced, the present invention shall be described in conjunction with the drawings set forth herein below:

FIG. 1 illustrates a prior art keyed, removable, double end mounted lamp having a step-in X location position features;

FIG. 2 illustrates a keyed, removable, double end mounted lamp having a step-out X location position features;

FIG. 3 illustrates a schematic view of a preferred keying ferrule/lamp mounting system;

FIG. 4 illustrates a schematic view of another preferred keying ferrule/lamp mounting system;

FIG. 5 illustrates a 3D view of a keyed lamp ferrules; and

FIG. 6 illustrates a detailed view of a lamp mounting system incorporated into reflector component.

### DETAILED DESCRIPTION OF THE INVENTION

The present invention is directed to a keyed, alignment free, removable, double end mounted lamps that are used in connection with a double sided mounting system, such as is used in an eele-enhanced® reflector or other multi reflector systems. In particular, this invention pertains to the field of micro display based projection display systems and fiber optic light sources.

Historically, eele-enhanced® reflectors have been manufactured with either a Ni electroforming manufacturing processes or a glass molding process. Both manufacturing processes copy the geometrical surface of a respective highly polished metal tool in an inverted (complimentary) manner. The manufacturing processes for such reflector tooling lends itself very naturally to the manufacturing of recessed (step-in) key alignment features on a non-optically relevant surface portion of the respective reflector manufacturing tool; such that they are actually become an integral part of the reflector component and therefore produce the highest accurate keyed alignment features between the optical reference points (focal points) of the respective reflector components and respective keyed lamp mounting locations.

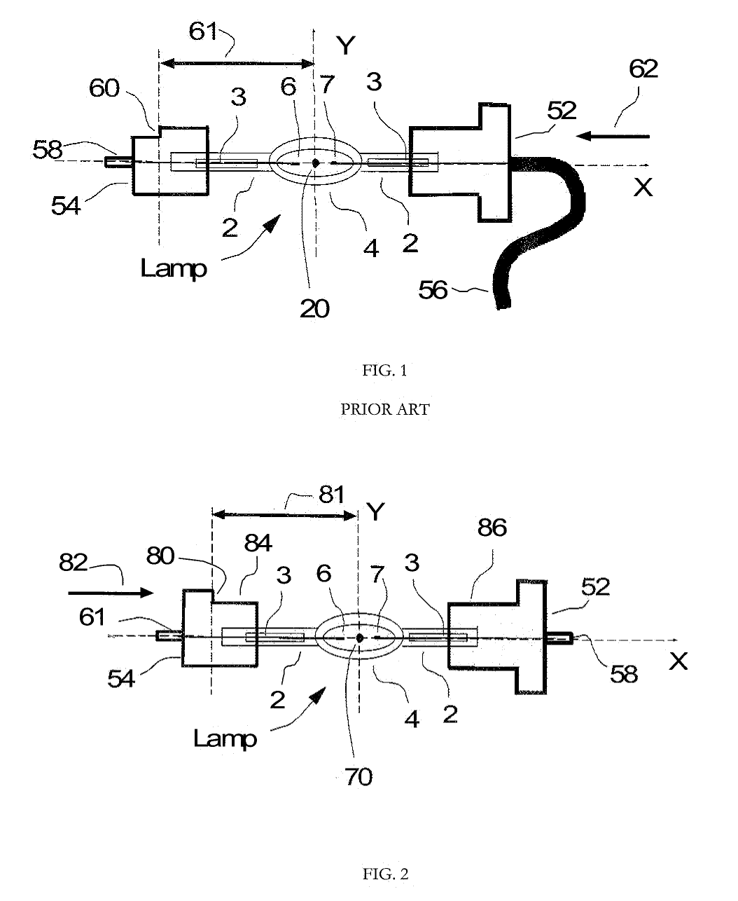

FIG. 1 illustrates a schematic view of a prior art, alignment free, keyed, removable lamp that has been used an inventor of the present invention in the last few years in connection with Ni electroformed eele-enhanced® reflectors. The two lamp posts 2 containing two Molybdenum foils 3 are connected mechanically and electrically to the envelope 4 which surround in an air tight manner an electrically excitable gas mixture that can be energized with the electrodes 6 and 7. In the case of an AC arc lamp, the middle point between the tips of the electrodes 6 and 7 form an optical center 20 that needs to be placed near a respective first focal point F1 of an eele-enhanced® primary reflector. Since the electrode tip location typically changes over the life to the arc lamp often a geometrical reference point RP (often also called optical center) is being used that is typically being derived from the two mass center points of the front portion of the electrode body, not just from the respective electrode tip locations for a brand new arc lamp. In the case of a DC arc lamp with asymmetric cathode and anode electrodes 6 and 7 the respective optical center 20 or reference point RP (as opposite to the center of the envelope 4) is typically located closer to the cathode type electrode tip than the respective anode tip.

The two lamp posts 2 are rigidly cemented to the lamp ferrules 52 and 54 (with the prior art second ferrule 54 having a step-in alignment feature 60 that provided a reference position location in the lamp axis direction X after the optical center 20 has been optically aligned with respect to the mechanical alignment features of the ferrules 52 and 54 to a given standard mechanical spatial reference distance 61 between the mechanical location features and the optical center 20. The step out feature of the prior art lamp ferrule 52 shown in FIG. 1 is not a location feature. It has been used in the prior art by one of the present inventors to increase the electrical path length from the envelope center to ground to minimize arcing to ground during the ignition period of the arc lamp. The electrical connection of the lamp can be made either with a permanent connected HV cable 56 or with a pin 58 that is seated in a proper spring loaded electrical ferrule (not shown in FIG. 1)

This prior art keyed removable lamp design is the most natural evolution from the standard Ni electroforming or glass molding manufacturing process that was historically used in the manufacturing of the prior art eele-enhanced® reflectors with built-in highly accurate ferrule mounting alignment features that are integral parts of the eele-enhanced® primary or retro reflector component, and such features are located on a non-optical critical portion of the reflector flange surface. In other words, since the electroforming or glass molding process is a complementary copy process that copies the inverted shape of a highly polished machined optical tool, the machining process used to manufacture the molding or electroforming tool guides the natural choice of alignment feature selection for the integrated lamp ferrule mounting key features. Since it is easier to remove material the natural result is that the copied mounting tool has alignment features that step-out and therefore the lamp mounting ferrule 54 has a step-in feature 60 that which needs to be pressed in the direction 62 to lock stably into a fixed X reference position, i.e. the pressure needs to come from the first ferrule 52 across the lamp L to the second ferrule 54 to keep the lamp position stable over many lamp turn on cycles.

However, extended lifetime testing and investigation of various failure modes has historically shown that with the pressure direction 62 compressing the envelope 4 is stressing the envelope and leads to an increased explosion rate over the life of the lamp. This problem increases with lamp age during which the mechanical integrity of the envelope is weakened due to a steadily increasing zone of quartz devitrification.

FIG. 2 illustrates a first preferred embodiment of the present invention where the prior art step-in alignment feature 60 of the ferrule 54 has been reversed to the step-out feature 80 which has a standard mechanical reference distance 81 against the optical center 70. While this feature reversal appears on first sight trivial, given the additional complication in tool manufacturing it was clearly not intuitive to those skilled in the art, i.e. including to ourselves, who have been making prior art keyed removable lamp components according to FIG. 1 for years.

The preferred embodiment of the present invention provides a slight force in the direction 82 against the electrical connection pin 61 or directly against the ferrule 54 to mechanically load the step-out features 80 against a matching step-in feature in a respective lamp mounting system without pre-stressing the lamp in its biggest thermal expansion direction. The preferred embodiment of the invention is independent on whether the respective lamp ferrule mounting system is an integral part of the reflector body or a separate mechanical component that also has a standard fixed spatial relationship to the first focal point of the respective reflector system. In this manner the optical center 70 of the lamp can be prealigned in the lamp factory utilizing the same mechanical key location features of the ferrule 52 and 54 that will be used by an end user for an alignment free (plug and play) precision placement of the optical center 70 near the first focal point F1 of a respective matched reflector system.

In another preferred embodiment of the present invention (shown/not shown), the ferrule 52 and 54 each have additional axial symmetric alignment feature section 84 and 86 that allows each respective ferrule to be located precisely and uniquely perpendicular to the lamp axis X, in a corresponding lamp holder. The ferrule 52 is preferably designed in such a manner that the X limit of the ferrule 52 has at least some translation freedom in the lamp axis direction. For example, according to this invention the X position tolerances of the ferrule 52 is greater than the maximum change in expansion length of the lamp during its on (hot) and off (cold) operation mode.

The preferred mounting system of the present invention (shown/not shown) has at a minimum five precision located mechanical contact points or surfaces, with two for the ferrule 52 and three for the ferrule 54 including the step-out features 80 and the latter is arranged in such a manner that the envelope 4 is free (unrestricted) to expand away from the stepped out features 80 in the X direction. Optionally at least one of the ferrules 52 or 54 has also a X-axis rotational limiting key features that also allows to preserve the axial orientation of the electrode tips as it has been optimally chosen during the manufacturing of the keyed removable lamp. For example, if the orientation of the illumination system utilizing such a keyed removable lamp is known at all times (for example for a rear projection display system application) the preferred rotational orientation of the electrodes 6 in the mounting ferrules 52 and 54 is such that the electrodes are pointed the farthest possible distance from the top of the envelope when its is installed (mounted) inside the projector. This will reduce the devitrification growth rate due to the increased distance from the electrode 6 tips to the top portion of the envelope 4.

Alternatively, if the lamp orientation of an end user application is unknown, for example for a front projector that can also be mounted upside down, it is known that the electrode tips need to be put in a plane that is horizontal with respect to gravity to avoid the greater problem that the shortest distance from the electrode 6 tips is for some installations on the top of the envelope (upside down installation). This alignment also minimizes the optical extent of the emission source (étendue) while simultaneously improving the average lifetime (reducing devitrification effects on average), which is particularly beneficial for the smallest size light valves which are most sensitive to an increase in the emission étendue over the life of the lamp.

In another preferred embodiment of the present invention, the two axial symmetric features 84 and 86 cover at least one portion of a cylindrical surface, and optionally, have either the same or a different diameter, or the mounting ferrules 54 and 52 have additional interlocking key features that prevent an accidental end user left/right inverted lamp installation.

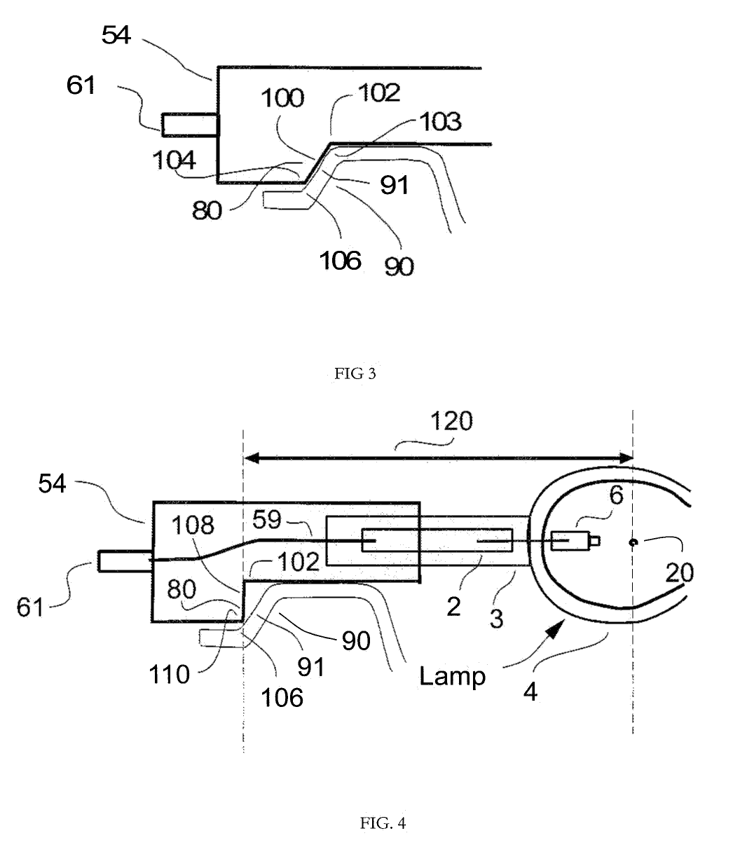

FIG. 3 is a schematic view of another preferred embodiment of the present invention. The ferrule 54 with the raised (step-out) alignment feature 80 and mounting system step-in feature 90 with the contact surface 91 is shown here with a sloped step-in transition surface 100 instead of the 90° step-out feature shown in FIG. 2. This is an improvement in the reproducibility of the interlocking alignment features between the locating step-out feature 80 and the mounting step-in feature 90 since the center flat or curved surface portion 100 of the feature 80 and of the sloped flat or curved surface portion 91 allow a more reproducible and more protected contact point so as to minimize if not eliminate the influence of any wear of inside or outside corners 102, 104 of ferrule 54 on the mechanical interlocking position 81. Instead, in this preferred embodiment only the protected portion of the two interlocking surfaces 100 and 91 is used for a mechanically interlock. FIG. 3 illustrates the radius of the inner corner 102 of the raised alignment feature is preferably smaller than the radius of the mounting system 103 such that the corners 102, 104 do not provide any interlocking interference. Similarly, the preferred step height of the raised step 80 is smaller than the step height of the mounting feature 90 so as to prevent the inner corner 106 from mechanically interlocking with the outer corner 104.

FIG. 4 illustrates another preferred embodiment of the present invention, with a 90 deg sloped step 108 on the mounting ferrule 54 together with a less than 90 deg sloped lamp holder alignment stop key 90 of the lamp mounting system. This mechanical interlock depends on the contact between a point or line 110 and a flat sloped surface 91 and as long it is mechanically stable it can be used therefore to transfer the standard distance 81 to the focal point FI of a respective reflector. In reality the sharp corner 110 is likely to be somewhat rounded. Thus, according to this invention, it is still possible to utilize somewhat miss matched step-out/step-in features (point to surface or point to point interlocking contacts) as long as the appropriate standard distances 120 between the interaction point/line 110 and the mounting surface 91 are appropriately been set at the lamp factory so that they can be used to transfer the alignment of the optical center 70 at the lamp factory by the end user to the F1 focal point of the respective mounted lamp reflector system.

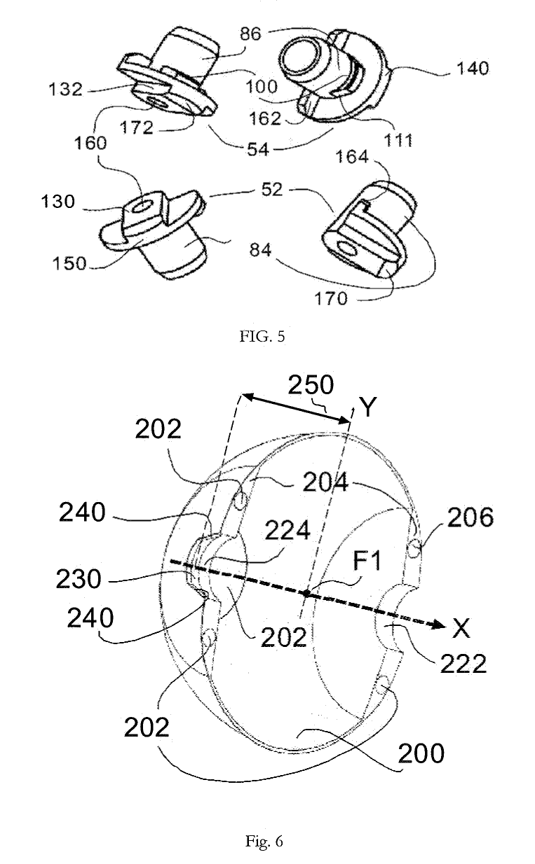

FIG. 5 illustrates another embodiment of the present invention where two matched ferrules 52 and 54 are shown incorporating additional key locating/differentiation features. The axial symmetric features 84 and 86 are shown here with a full cylindrical shape. The second ferrule 54 has a short sloped raised key locating surface 100 that is limited laterally by the tapered feature 111 therefore providing both an X-location position key as well as an axial rotational key lock with a tapered guide that facilitates the proper rotational orientation key lock insertion. The additional rotational lock key 130 and 132 have different widths so that with a matching lamp holding key feature an accidental and improper transposing of ends or more simply, an inverted lamp insertion is prevented by an easy recognizable positive mechanical interlock. The optional partial circumferential disk 140 and 150 provide an increased electrical path in free air to prevent arc over from the electrical center pin that will be inserted through the hole 160 during the lamp assembly process (not shown in FIG. 5) and grounded metal reflector during the high voltage ignition phase.

Additional wings 162 and 164 can also be used to increase the electrical path length while simultaneously allowing forced air to blow over the other side of the lamp axis to cool the top of the envelope. The sloped surface 170 and 172 provides a plurality of purposes, first as an insertion guide key for the alignment surface 100 to prealigned it near its optimum location, and second, as a mechanical interlock which prevents insertion into the holder (for example if it is missing) if the style of the lamp is incorrect. The latter prevents accidental insertion of the incorrect lamp type in to a reflector holder designed for a particular illumination product family.

The distance between the disk features 140 and 150 can be used in a similar manner to prevent accidental insertion of the incorrect lamp type into a given lamp mount. Additionally, optical color and/or bar code keys, magnetic printed keys, additional recessed step-in and step-out mechanical features, etc. can be incorporated to mark the ferrules 52 and 54 to further prevent accidental use of the incorrect lamp type, especially if the power supply is interlocked to at least one family recognition feature, wherein power up is permitted only when a proper key sequence is recognized. These activation keys could also be entered through a remote keypad or other control button(s) that are part of the illumination product.

In another embodiment of the present invention, a delivery tool U.S. patent application Ser. No. 11/419,976 is used to deliver the lamp to the lamp mounting while it is protected during the transport. Besides the mechanical key system discussed in the reference, the delivery tool or the related packaging material preferably contains an alpha numeric key sequence that the user gains access to only after removal of the lamp from the delivery tool. This key sequence is then preferably used to further authorize the lamp activation through a software check protocol that recognizes the lamp type and the illumination system, and verifies compatibility there between. Optionally, such sequence may authorize a time limited use of such a lamp to prevent an increase failure rate inside the illumination system caused in whole or impart by an overuse (e.g., beyond a recommended statistical safe operation time) of such a customer replaceable lamp by the end user.

Ideally the present invention provides a defense against the first line of end user error, namely, a series of mechanical interlocking key features that provide an alignment free lamp insertion, but also prevent the accidental insertion of the incorrect lamp type. Moreover, the present invention provides a second line of defense wherein the design limits the over usage of such a lamp by the end user, by going through a time limiting authorization procedure. This procedure is integrates with the internal software of the illumination product which is reset every time a new lamp is inserted and wherein a respective activation procedure needs to be successful completed to restart the lamp usage timer.

FIG. 6 illustrates a portion of a lamp mounting system that can be cooperatively connected to ferrules 52, 54. The eele-enhanced® retro reflector 200 has an exit hole 202 and a flange 204 with key alignment features 206 that can be used to mechanically align the retro reflector 200 to a respective eele-enhanced® primary reflector and to an optional lamp mounting system (both not shown in FIG. 6). A portion of the lamp mounting system matched to a lamp according to the present invention is incorporated as ferrule holders 222, 224 shown here as semi-cylindrical, axial symmetric surfaces that confine ferrules 52, 54 perpendicularly to lamp axis X. The step-in sloped surface 230 confined laterally by the two side walls 240 provide the key for locating the step-out feature 100 with the lateral limitation feature 111, thus providing both a unique stop in the X-axis direction, and a rotational lock in the lamp axis direction. The key features 230 have a standard spatial distance relationship 250 to the first focal point FI of the respective eele-enhanced® reflector system of which reflector 200 is a component thereof.

Thus, FIG. 6 illustrates the integration of a reflector and a basic keyed double side lamp mounting system. Additional lamp type differentiation keys and/or guiding insertion keys, located for example on the left and/or right side of the ferrule holders 222, 224 and not shown in FIG. 6, can be used to limit the end user to insert only the correct lamp type into the proper mounting position.

All of the above referenced patents; patent applications and publications are hereby incorporated by reference. Many variations of the present invention will suggest themselves to those of ordinary skill in the art in light of the above detailed description. All such obvious modifications are within the full-intended spirit and scope of the claims of the present application both literally and in equivalents recognized at law.

What is claimed is:

1. A keyed replaceable lamp comprising:
an arc lamp and a first and a second keyed lamp ferrule,
wherein said arc lamp has a center envelope section that encloses an optical reference point RP and which is rigidly connected to two opposing lamp posts forming a lamp axis X and partially orienting a lamp coordinate system having a point of origin at RP, and wherein each of said ferrules is rigidly mechanically connected to a different one of said lamp posts,
wherein said first ferrule has at least two locating features that have a fixed predetermined geometrical relationship to said point RP in at least one of the axis of said lamp coordinate system and with one of said two locating features (SO) stepping out from said lamp axis X direction and locating said ferrule in a direction perpendicular to said axis X, and
wherein said second ferrule has at a minimum one locating feature having a fixed predetermined geometrical relationship to said point RP in at least one of said axis of said lamp coordinate system.

2. A keyed lamp as in claim 1, wherein said step out feature of said first ferrule has a transition from a first height to a second height selected from the group consisting of: a 90 degree step, a sloped step, and a curved step transition, a step with sharp corners, a step with rounded corners and wherein said locating features are precision aligned to said point RP to better than 0.5 mm.

3. A keyed lamp as in claim 2, wherein said lamp coordinate system is a cylindrical system and where one of said locating features is at least a partial cylindrical axial locating feature (C) that covers at least a 15 deg portion of an arc perpendicular to the lamp axis X, to uniquely locate said reference point RP perpendicular to said lamp axis X without limiting its position perpendicular to said lamp axis.

4. A keyed lamp as in claim 3, wherein said raised step out feature (SO) includes a 110+/−10 deg sloped step transition surface that is perpendicular to the symmetry axis of said cylindrical feature (C) over an arc of at least 2 deg perpendicular to the lamp axis X and where the center portion of said sloped step out transition surface is the respective step out locating feature of said first ferrule.

5. A keyed lamp as in claim 2, wherein at least one of said ferrules includes a non-axial rotational symmetric feature that provides a unique rotational keyed alignment feature preventing the installation of such a keyed lamp into a matching holder with an incorrect axial orientation perpendicular to said lamp axis X.

6. A keyed lamp as in claim 2, wherein said lamp is compatible with an eele-enhanced® reflector.

7. A keyed lamp as in claim 2, wherein said lamp is compatible with a keyed lamp holder having a fixed spatial relationship with respect to the first focal point of the primary reflector of an eele-enhanced® reflector.

8. A keyed lamp as in claim 2, wherein said lamp is compatible with a keyed lamp holder that has at least one matching key location features built into an eele-enhanced® reflector having a matched delivery tool substantially enclosing said keyed lamp during the action selection from the group consisting of inserting, and removing said keyed lamp from said reflector holder with matching key set.

9. A keyed lamp as in claim 2, wherein at least of one of said ferrules include a rotational alignment key that uniquely engages with a matching rotational alignment key of a respective delivery tool.

10. A keyed lamp as in claim 2, wherein said ferrules include additional keys to uniquely identify the lamp usage selected from a group consisting of: step in and step out mechanical keys, printed and non printed keys, monochrome and color coated keys, magnetic encoded keys, electrical conductive, and embedded chip keys communicating ID features upon interrogations.

11. A keyed lamp as in claim 2, wherein at least one of said ferrules include a non step out feature which increases the electrical conductive path length to ground between the lamp posts and the nearest ground point.
